(19) United States
(12) Patent Application Publication
(10) Pub. No.: US 2026/0264571 A1
(43) Pub. Date: Sep. 10, 2026

(54) SYSTEMS AND METHODS FOR INTEGRATED DRIVE MODULE INEFFICIENCY MODE

(71) Applicant: BorgWarner Inc., Auburn Hills, MI (US)

(72) Inventors: Gregory Thomas ROTH, Harrison, MI (US); Joseph TYCKOWSKI, Ortonville, MI (US)

(73) Assignee: BorgWarner Inc., Auburn Hills, MI (US)

(21) Appl. No.: 19/072,296

(22) Filed: Mar. 6, 2025

(51) Int. Cl. B60L 58/27

(52) U.S. Cl. CPC B60L 58/27; B60L 2210/40

(57) ABSTRACT

A system includes: a power converter, the power converter including: one or more switches; and one or more controllers configured to control the one or more switches in each of an efficiency control mode to operate a load and an inefficiency control mode to generate heat from the one or more switches.

### TECHNICAL FIELD

Various embodiments of the present disclosure relate generally to systems and methods for implementing an integrated drive module (IDM) inefficiency mode, and, more particularly, to systems and methods for generating heat using an inverter to indirectly warm a high voltage battery and other systems of an electric vehicle.

### BACKGROUND

A major focus in IDM development is to maximize efficiency of the system to increase battery electric vehicles (BEVs) range. In cold weather, the vehicle may experience reduced performance due to limited current output of a cold battery. Some vehicles employ an electric coolant heater to help warm the battery to a point of sufficient current output for vehicle performance needs. However, adding an electric coolant heater is expensive, reduces reliability, and limits BEV range.

The present disclosure is directed to overcoming one or more of these above-referenced challenges.

### SUMMARY OF THE DISCLOSURE

In some aspects, the techniques described herein relate to a system including a power converter, the power converter may include: one or more switches; and one or more controllers configured to control the one or more switches in each of an efficiency control mode to operate a load and an inefficiency control mode to generate heat from the one or more switches.

In some aspects, the techniques described herein relate to a system, wherein an inefficiency control mode may be configured to transfer generated heat from a power converter to a coolant system.

In some aspects, the techniques described herein relate to a system, wherein an inefficiency control mode may operate in a zero-torque condition at a zero speed.

In some aspects, the techniques described herein relate to a system, wherein one or more switches may include one or more high side switches and one or more low side switches.

In some aspects, the techniques described herein relate to a system, wherein an inefficiency control mode may operate in a zero-torque condition at a non-zero speed.

In some aspects, the techniques described herein relate to a system, wherein an inefficiency control mode may operate in a negative torque condition at a non-zero speed.

In some aspects, the techniques described herein relate to a system, wherein one or more controllers may be configured to control one or more switches in a partially-on state in an inefficiency control mode.

In some aspects, the techniques described herein relate to a system, wherein one or more controllers may be configured to control one or more switches at a higher switching frequency in an inefficiency control mode than in an efficiency control mode.

In some aspects, the techniques described herein relate to a system, wherein the power converter further may include: an oscillator input circuit for an inefficiency control mode.

In some aspects, the techniques described herein relate to a system, wherein: one or more switches include: one or more high side switches; and one or more low side switches, and in an inefficiency control mode, one or more controllers may be configured to: turn on the one or more high side switches; and after a first time period based on a drive switching frequency, turn off the one or more high side switches and turn on the one or more low side switches.

In some aspects, the techniques described herein relate to a system, wherein one or more controllers operating in an inefficiency control mode may be further configured to control an operation of one or more high side switches and one or more low side switches with an overlap between a high side switch voltage decay and a low side switch voltage rise to reduce a delay time between switching the one or more high side switches and the one or more low side switches.

In some aspects, the techniques described herein relate to a system, further including: a motor connected to the power converter, wherein the system is provided as an electric vehicle.

In some aspects, the techniques described herein relate to a system including: one or more controllers configured to control one or more switches of a power converter in each of an efficiency control mode to operate a load and an inefficiency control mode to generate heat from one or more switches.

In some aspects, the techniques described herein relate to a system, wherein one or more controllers may be configured to control a heat flow from a power converter to a coolant.

In some aspects, the techniques described herein relate to a system, wherein one or more controllers may be configured to control heat output by modulating a duty cycle of one or more switches.

In some aspects, the techniques described herein relate to a system, wherein one or more controllers operating in an inefficiency control mode may be configured to reduce a delay time between switching operations of one or more switches.

In some aspects, the techniques described herein relate to a method including: controlling one or more switches of a power converter which may operate in each of an efficiency control mode to operate a load and an inefficiency control mode to generate heat from the one or more switches.

In some aspects, the techniques described herein relate to a method, wherein the controlling may include controlling one or more switches to operate in an inefficiency control mode to increase one or more of a conduction loss or a switching loss of the one or more switches.

In some aspects, the techniques described herein relate to a method, wherein the controlling may include controlling one or more switches to operate in an inefficiency control mode during a remote start feature of a vehicle.

In some aspects, the techniques described herein relate to a method, which may include controlling a duty cycle of one or more switches operating in an inefficiency control mode to modulate a delay time between operations of the one or more switches.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure for a vehicle including a power converter, according to one or more embodiments.

FIG. 2 depicts an exemplary system infrastructure for a power converter, according to one or more embodiments.

FIG. 3 depicts an exemplary system infrastructure for a controller, according to one or more embodiments.

FIG. 4 depicts an exemplary system infrastructure for a vehicle coolant system, according to one or more embodiments.

FIG. 5 depicts an exemplary system infrastructure for a motor cooling and lubrication system, according to one or more embodiments.

FIG. 6 depicts an exemplary system infrastructure for an IDM electrical control system, according to one or more embodiments.

FIG. 7 depicts an exemplary system infrastructure for a vehicle and IDM control system, according to one or more embodiments.

### DETAILED DESCRIPTION OF EMBODIMENTS

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. For example, in the context of the disclosure, switching devices may be described as switches or devices, but may refer to any device for controlling the flow of power in an electrical circuit. For example, switches may be metal-oxide-semiconductor field-effect transistors (MOSFETs), bipolar junction transistors (BJTs), insulated-gate bipolar transistors (IGBTs), or relays, for example, or any combination thereof, but are not limited thereto.

Various embodiments of the present disclosure relate generally to systems and methods for implementing an integrated drive module (IDM) inefficiency mode, and, more particularly, to systems and methods for generating heat using an inverter to warm a high voltage battery or other vehicle system.

Inverters, such as those used to drive a motor in an electric vehicle, for example, are responsible for converting High Voltage Direct Current (HVDC) into Alternating Current (AC) to drive the motor. A three-phase inverter may include a bridge with six power device switches (for example, power transistors such as IGBT or MOSFET) that are controlled by Pulse Width Modulation (PWM) signals generated by a controller. An inverter may include three half-H bridge switches to control the phase voltage, upper and lower gate drivers to control the switches, a PWM controller, and glue logic between the PWM controller and the gate drivers. The PWM controller may generate signals to define the intended states of the system. The gate drivers may send the signals from the PWM controller to the half-H bridge switches. The half-H bridge switches may drive the phase voltage. Six phase (or other phase) inverters, chargers, DC-DC converters, and/or multi-level inverters are not excluded from this concept and will follow similar principles. The present disclosure refers to an inverter as an example embodiment of a power converter. Power converters may include chargers, inverters, or DC-DC converters, for example.

Electric vehicles, energy storage systems, and backup generators, for example, convert electric power from one form to another. Additionally, an on-board charger for a vehicle, for example, may have a dual purpose. The on-board charger may be a bi-directional system that converts AC voltage to DC voltage in a charging mode (grid-to-battery) and DC voltage to AC voltage in a discharge or inverter mode (battery-to-grid). The charging mode may convert the grid AC into DC voltage to charge the vehicle high voltage (HV) battery, and the discharge or inverter mode may convert the HV battery DC voltage into AC voltage that may be supplied to a load of the grid line voltage, be supplied as a backup generator to power a house when the grid is down, or as an inverter to supply voltage to vehicle AC outlets, for example.

The system and method for implementing the IDM inefficiency mode may employ active idle functions to generate heat and transfer the heat to vehicle components. Currently, some active idle functions for vehicles are applicable to zero speed conditions and activate only three of six inverter switches. Improperly activating the switches may negatively affect one or more of the six switches at any instant by, for example, creating short circuits, generating component stress, increasing electromagnetic noise, and reducing power quality. Although off-axis Id current may be effective for increasing energy loss, torque error considerations, and losses in the motor windings which absorb heat reduce the effectiveness of the solution.

One or more embodiments may provide a method and system for intentionally creating an inefficiency mode for an inverter to produce heat via electrical losses. The heat may be indirectly transferred to a high voltage battery to warm the battery during cold temperatures without the use of an electric coolant heater. The inefficiency mode, in which the IDM is intentionally run in an inefficient manner, may induce additional heat flow into a coolant system via electrical losses without generating mechanical output torque or additional output torque. The inefficiency mode may eliminate the need for an electric coolant heater thereby reducing vehicle cost and complexity and improving vehicle reliability.

One or more embodiments may exploit switching losses in power electronics components by creating a separate inefficiency control mode for zero-torque conditions. Alternatively, the inefficiency control mode may exploit switching losses for non-zero torque conditions. The inefficiency control mode may be effective at zero and non-zero speeds. The inefficiency control mode may avoid all other control calculations (ignoring rotor position etc.) to allow much shorter control loop times (and therefore much higher switching frequencies). The inefficiency control mode may allow for switching frequencies up to the limits of the power electronics devices. A separate oscillator input circuit may be switched into the gate drive for faster switching.

One or more embodiments may increase switching losses by modulating a drive switching frequency and switching operations of the three high side switches of the inverter and the three low side switches of the inverter during an inefficiency control mode. For example, turning on all three high side switches of the inverter at the same time for a first time period, then turning off all three high side switches and turning on all three low side switches at the same time at a first switching rate, where the first switching rate is above a rate employed during an efficiency control mode. The switching operations may include one or more switches. The time delay between switching operations may be modulated to produce maximum switching losses.

One or more embodiments may provide for operating the drive switching frequency to the maximum rate and duty cycle possible. For example, for non-zero speeds with a Permanent Magnet Synchronous Motor (PMSM), enabling Inefficiency Mode and operating the drive switching frequency above the maximum rate possible during normal motor control mode may create additional losses in inverter and motor due to a short circuit condition it would create on the motor. These losses may result in additional heat which may be absorbed by the coolant and transferred to the HV battery.

One or more embodiments may provide for modulating a duty cycle of the switches to produce maximum electrical losses while avoiding excessive negative torque. Operating in inefficiency mode and operating the drive switching frequency above the maximum rate possible during normal motor control mode at non-zero speeds may create braking torque from the motor thereby reducing vehicle speed and absorbing vehicle kinetic energy. The vehicle control system may modulate a duty cycle during the inefficiency mode to avoid excessive negative propulsion system torque. The resulting losses from this control mode would be higher than those in a normal regenerative braking condition. For example, when using the inefficiency mode in induction motors, a rotor field could be disabled or reduced to minimize braking torque.

One or more embodiments may provide for controlling a duty cycle of the switches during the inefficiency mode by modulating the delay time between switch set triggers. Modulating the delay time or the dead time between transitions may involve creating a very slight overlap between high side switch voltage decay and low side switch voltage rise. The overlap may be small to avoid excessive currents in a short circuit situation. Additionally, both high side and low side switches may be enabled simultaneously with an extremely low gate drive input to create a partially-on condition in all switches, thereby acting as a high-resistance short circuit through all switches.

One or more embodiments may provide for maximizing energy produced by the inefficiency mode by tuning the switch-on to switch-off transition to maximize energy loss of the full circuit. Tuning would not require down time to wait for a switch to fully complete a rise time event, thereby generating additional heat and reducing battery heating time.

One or more embodiments may provide for running an inverter in an inefficiency control mode during different, flexible circumstances. The inefficiency mode may be operated when the vehicle is off. The vehicle may be unoccupied, similar to a remote start feature. The inverter may run in an inefficiency control mode during a battery charging event or a pre-programmed time-of-day planned trip. Designing the inefficiency control mode to run under different and varied conditions allows for greater flexibility and improved functionality. Heating during battery charging and a ‘remote start’ or programmed pre-warming mode may accomplish battery heating prior to a vehicle drive event.

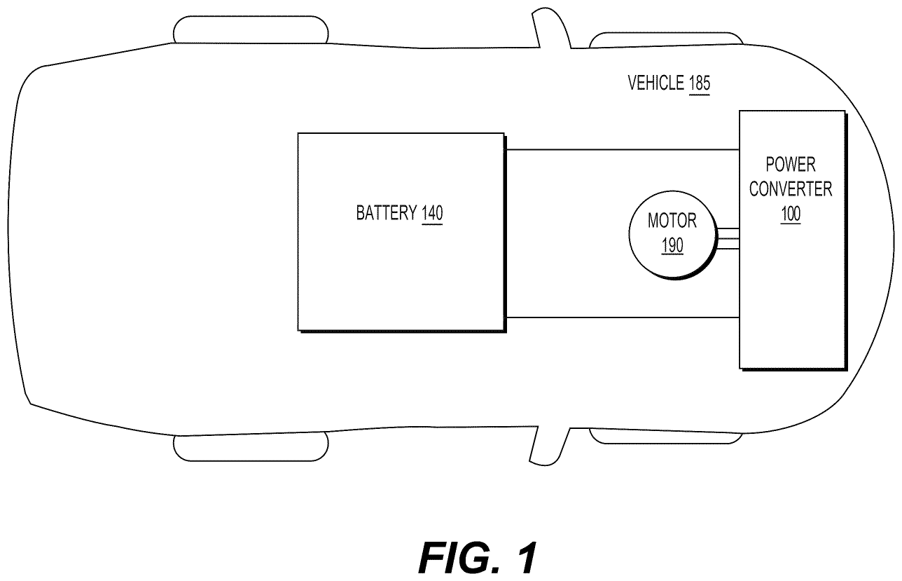

FIG. 1 depicts an exemplary system infrastructure for a vehicle including a power converter, according to one or more embodiments. The power converter 100 may be a combined inverter and converter. Alternatively, the inverter may be an inverter without a converter. In the context of this disclosure, a battery charger, the inverter, the converter, or any combination thereof may be referred to as power converter 100. Electric vehicle 185 may include power converter 100, motor 190, and HV battery 140. Power converter 100 may include components to receive electrical power from an external source and output electrical power to charge HV battery 140 of electric vehicle 185. Power converter 100 may convert DC power from HV battery 140 in electric vehicle 185 to AC power, to drive motor 190 of the electric vehicle 185, for example, but the embodiments are not limited thereto. For example, power converter 100 may include components to receive electrical power from an external source and output electrical power to charge HV battery 140 without motor 190 connected to power converter 100. Power converter 100 may convert DC power from HV battery 140 in electric vehicle 185 to AC power, to drive AC components other than motor 190 of the electric vehicle 185. Power converter 100 may be bidirectional, and may convert DC power to AC power, or convert AC power to DC power, such as during regenerative breaking, for example. Power converter 100 may be a three-phase inverter, a single-phase inverter, or a multi-phase inverter.

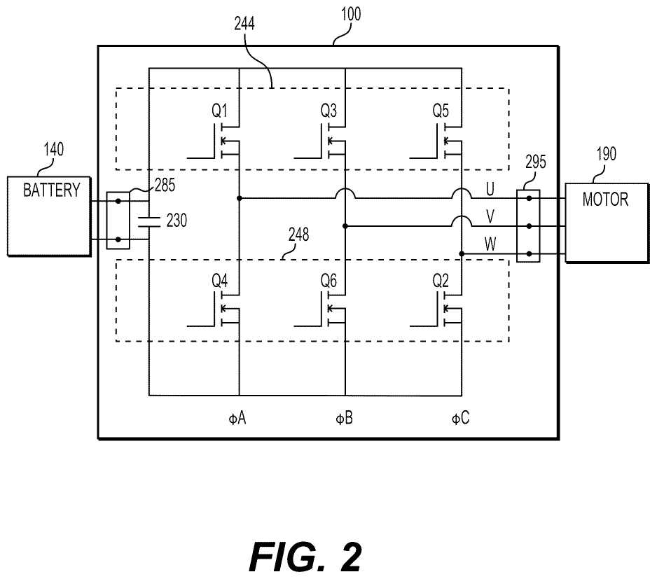

FIG. 2 depicts an exemplary system infrastructure for a power converter, according to one or more embodiments. Power converter 100 may be used to convert DC power from a battery in electric vehicle 185 to AC power, to drive motor 190 of electric vehicle 185, for example, but embodiments are not limited thereto. Additionally, power converter 100 may be bidirectional, and used to convert DC power to AC power, or to convert AC power to DC power.

Power converter 100 may be connected to HV battery 140 and motor 190. Power converter 100 may include upper phase switches 244 and lower phase switches 248. A first phase (φA) may include switches Q1 and Q4, a second phase (φB) may include switches Q3 and Q6, and a third phase (φC) may include switches Q5 and Q2. Upper phase switches 244 may include first phase switch Q1, second phase switch Q3, and third phase switch Q5. Lower phase switches 248 may include first phase switch Q4, second phase switch Q6, and third phase switch Q2. Switches Q1-Q6 may be metal-oxide-semiconductor field-effect transistors (MOSFET), for example, but embodiments are not limited thereto.

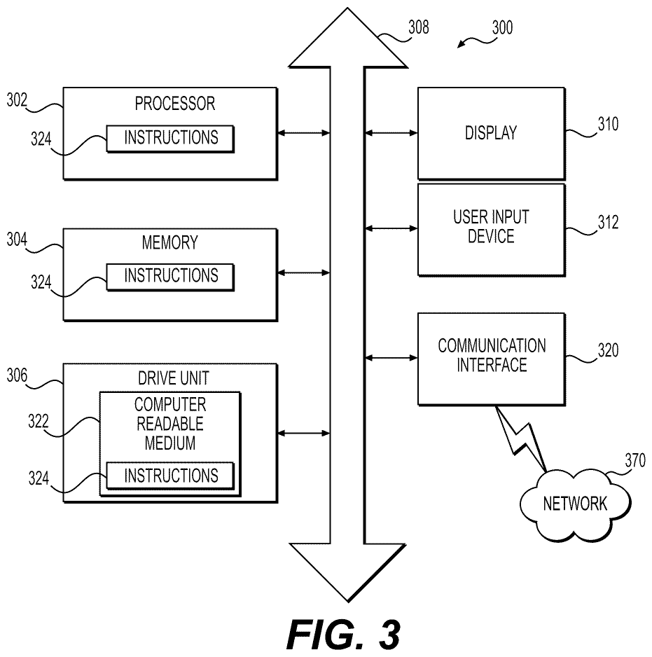

Upper phase switches 244 and lower phase switches 248 may be driven by a pulse width modulated (PWM) signal generated by controller 300 (e.g., see FIG. 3) to convert DC power delivered via the set of input terminals 285 at bulk capacitor 230 to three phase AC power at outputs U, V, and W (correlating with phases A, B, and C, respectively) via the set of output terminals 295 to motor 190. Additionally, although FIG. 2 depicts a three-phase inverter, the disclosure is not limited thereto and may include single phase or multi-phase or multi-level inverters.

FIG. 3 depicts an exemplary system infrastructure for a controller, according to one or more embodiments. Controller 300 may include one or more controllers.

The controller 300 may include a set of instructions that can be executed to cause the controller 300 to perform any one or more of the methods or computer-based functions disclosed herein. The controller 300 may operate as a standalone device or may be connected, e.g., using a network, to other computer systems or peripheral devices.

In a networked deployment, the controller 300 may operate in the capacity of a server or as a client in a server-client user network environment, or as a peer computer system in a peer-to-peer (or distributed) network environment. The controller 300 can also be implemented as or incorporated into various devices, such as a power converter, a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 300 can be implemented using electronic devices that provide voice, video, or data communication. Further, while the controller 300 is illustrated as a single system, the term “system” shall also be taken to include any collection of systems or sub-systems that individually or jointly execute a set, or multiple sets, of instructions to perform one or more computer functions.

As depicted in FIG. 3, the controller 300 may include a processor 302, e.g., a central processing unit (CPU), a graphics processing unit (GPU), or both. The processor 302 may be a component in a variety of systems. The processor 302 may be one or more general processors, digital signal processors, application specific integrated circuits, field programmable gate arrays, servers, networks, digital circuits, analog circuits, combinations thereof, or other now known or later developed devices for analyzing and processing data. The processor 302 may implement a software program, such as code generated manually (i.e., programmed).

The controller 300 may include a memory 304 that can communicate via a bus 308. The memory 304 may be a main memory, a static memory, or a dynamic memory. The memory 304 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 304 includes a cache or random-access memory for the processor 302. In alternative implementations, the memory 304 is separate from the processor 302, such as a cache memory of a processor, the system memory, or other memory. The memory 304 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 304 is operable to store instructions executable by the processor 302. The functions, acts or tasks illustrated in the figures or described herein may be performed by the processor 302 executing the instructions stored in the memory 304. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As depicted, the controller 300 may further include a display 310, such as a liquid crystal display (LCD), an organic light emitting diode (OLED), a flat panel display, a solid-state display, a cathode ray tube (CRT), a projector, a printer or other now known or later developed display device for outputting determined information. The display 310 may act as an interface for the user to see the functioning of the processor 302, or specifically as an interface with the software stored in the memory 304 or in the drive unit 306.

Additionally or alternatively, the controller 300 may include an input device 312 configured to allow a user to interact with any of the components of controller 300. The input device 312 may be a number pad, a keyboard, or a cursor control device, such as a mouse, or a joystick, touch screen display, remote control, or any other device operative to interact with the controller 300.

The controller 300 may also or alternatively include drive unit 306 implemented as a disk or optical drive. The drive unit 306 may include a computer-readable medium 322 in which one or more sets of instructions 324, e.g. software, can be embedded. Further, the instructions 324 may embody one or more of the methods or logic as described herein. The instructions 324 may reside completely or partially within the memory 304 and/or within the processor 302 during execution by the controller 300. The memory 304 and the processor 302 also may include computer-readable media as discussed above.

In some systems, a computer-readable medium 322 includes instructions 324 or receives and executes instructions 324 responsive to a propagated signal so that a device connected to a network 370 can communicate voice, video, audio, images, or any other data over the network 370. Further, the instructions 324 may be transmitted or received over the network 370 via a communication port or interface 320, and/or using a bus 308. The communication port or interface 320 may be a part of the processor 302 or may be a separate component. The communication port or interface 320 may be created in software or may be a physical connection in hardware. The communication port or interface 320 may be configured to connect with a network 370, external media, the display 310, or any other components in controller 300, or combinations thereof. The connection with the network 370 may be a physical connection, such as a wired Ethernet connection or may be established wirelessly as discussed below. Likewise, the additional connections with other components of the controller 300 may be physical connections or may be established wirelessly. The network 370 may alternatively be directly connected to a bus 308.

While the computer-readable medium 322 is depicted to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 322 may be non-transitory and may be tangible.

The computer-readable medium 322 can include a solid-state memory such as a memory card or other package that houses one or more non-volatile read-only memories. The computer-readable medium 322 can be a random-access memory or other volatile re-writable memory. Additionally or alternatively, the computer-readable medium 322 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 300 may be connected to a network 370. The network 370 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to, TCP/IP based networking protocols. The network 370 may include wide area networks (WAN), such as the Internet, local area networks (LAN), campus area networks, metropolitan area networks, a direct connection such as through a Universal Serial Bus (USB) port, or any other networks that may allow for data communication. The network 370 may be configured to couple one computing device to another computing device to enable communication of data between the devices. The network 370 may generally be enabled to employ any form of machine-readable media for communicating information from one device to another. The network 370 may include communication methods by which information may travel between computing devices. The network 370 may be divided into sub-networks. The sub-networks may allow access to all of the other components connected thereto or the sub-networks may restrict access between the components. The network 370 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component or object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the operations of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

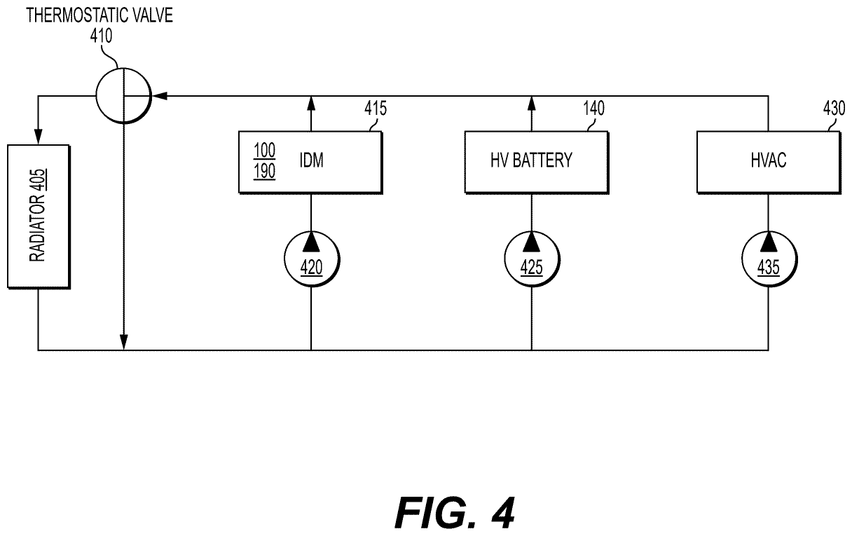

FIG. 4 depicts an exemplary system infrastructure for a vehicle coolant system 485. Vehicle coolant system 485 may include heating, ventilation, and air conditioning (HVAC) 430, HV battery 140, integrated drive module (IDM) 415, radiator 405, thermostatic valve 410, IDM pump 420, HV battery pump 425, and HVAC pump 435. IDM 415 may include power converter 100 and motor 190.

Controller 300 may receive vehicle component temperatures from vehicle component sensors and determine to warm a vehicle component using vehicle coolant system 485. Controller 300 may control vehicle coolant flow via one or more of thermostatic valve 410, IDM pump 420, HV battery pump 425, or HVAC pump 435. Thermostatic valve 410 may comprise one or more temperature sensors. Thermostatic valve 410 may regulate the flow of coolant through the one or more vehicle components by controlling the flow of the coolant based on the temperature of the component. For example, as depicted in FIG. 4, thermostatic valve 410 may control the flow of coolant through radiator 405. In some instances, thermostatic valve 410 may direct a portion of the coolant through radiator 405 and direct the remaining coolant portion to bypass radiator 405. Alternatively, thermostatic valve 410 may direct the entire portion of the coolant through radiator 405 or divert the entire portion of the coolant away from radiator 405.

Controller 300 may direct all of the coolant flow or a part of the coolant flow into IDM 415 via IDM pump 420, into HV battery 140 via HV battery pump 425, and into HVAC 430 via HVAC pump 435 based on thermal requirements of the system. For example, during the above-described situation where cold weather may degrade the battery range of HV battery 140, controller 300 may implement an inefficient mode, where one or more of upper phase switches 244 or lower phase switches 248 in power converter 100 may be modulated to create heat. Controller 300 may direct coolant through IDM 415 to absorb the heat created by the switches, and then direct the coolant through thermostatic valve 410 and into HV battery 140 via HV battery pump 425. Controller 300 may dynamically monitor the temperature of the vehicle coolant system 485 and direct the coolant accordingly. For example, controller 300 may direct the coolant to other elements of electric vehicle 185, such as the braking system and motor 190.

As the coolant flows through vehicle coolant system 485, heat may be transferred using one or more heat sinks, fans, thermal plates, heat exchangers, thermal pads, heat fins, heat jackets, thermoelectric coolers (e.g., Peltier modules), reservoirs, compressors, and other like devices that transfer heat. Vehicle coolant system 485 may comprise one or more coolants. The one or more coolants may be a single liquid or a combination of liquids such as one or more of water, a water-based liquid, oil, an oil-based liquid, or a similar fluid. For example, the one or more coolants may contain ethylene glycol, propylene glycol, synthetic oils, hydrocarbon-based fluids, or other heat transferring fluids. The one or more coolants may comprise one or more non-conductive dielectric properties and phase changing properties.

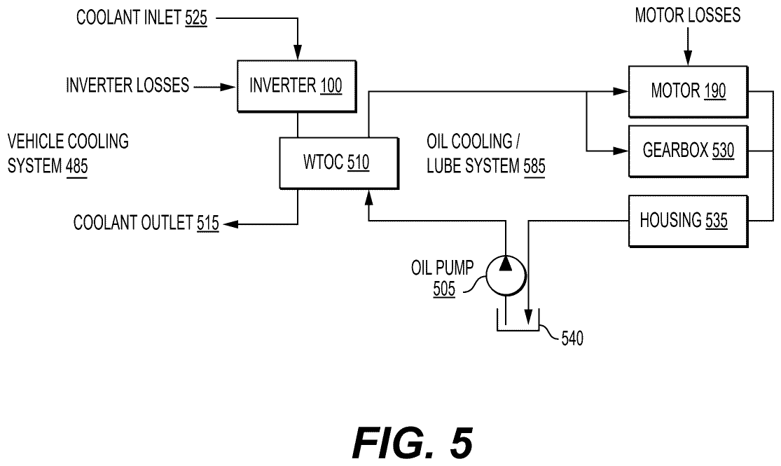

FIG. 5 depicts an exemplary system infrastructure for a motor cooling and lubrication system, according to one or more embodiments. FIG. 5 depicts IDM lubrication system 585 and a portion of vehicle coolant system 485. Vehicle coolant system 485 is described in the description of FIG. 4. As shown in FIG. 5, vehicle coolant system 485 may include the coolant system relating to IDM 415 and power converter 100, as described in the description of FIG. 4, and further depicts coolant inlet 525 and coolant outlet 515.

IDM lubrication system 585 may include IDM 415 and motor 190, as described in the description of FIG. 4, and further include gearbox 530, housing 535, drive unit oil reservoir 540, and oil pump 505. IDM lubrication system 585 may include water-to-oil-cooler (WTOC) 510. Housing 535 may enclose motor 190 and gearbox 530 and absorb heat generated by those components. Lubricant, such as gear oil, may be stored at drive unit oil reservoir 540. The lubricant may be used to lubricate working components in motor 190 and gearbox 530 and act as a coolant to the components by absorbing generated heat.

Controller 300 may direct lubricant through IDM lubrication system 585 using oil pump 505. Controller 300 may use one or more temperature sensors or estimators located on the system elements and throughout the system to circulate lubricant through IDM lubrication system 585. For example, controller 300 may employ oil pump 505 to deliver lubricant to motor 190 and gearbox 530. The lubricant may absorb heat generated by motor 190 and gearbox 530 while lubricating the parts therein. The lubricant may be channeled through housing 535 to absorb the heat stored at housing 535.

Lubricant may be circulated to WTOC 510, where heat from the lubricant may be transferred to the coolant. Power converter 100 may receive coolant at coolant inlet 525. Coolant may absorb heat generated by inverter losses in power converter 100, as described above. The heated coolant may exit power converter 100 and enter WTOC 510. Heat absorbed by the lubricant may be transferred to the coolant at WTOC 510. The coolant, having collected heat from motor 190, gearbox 530, and housing 535 via the lubricant, may exit the WTOC 510 at coolant outlet 515.

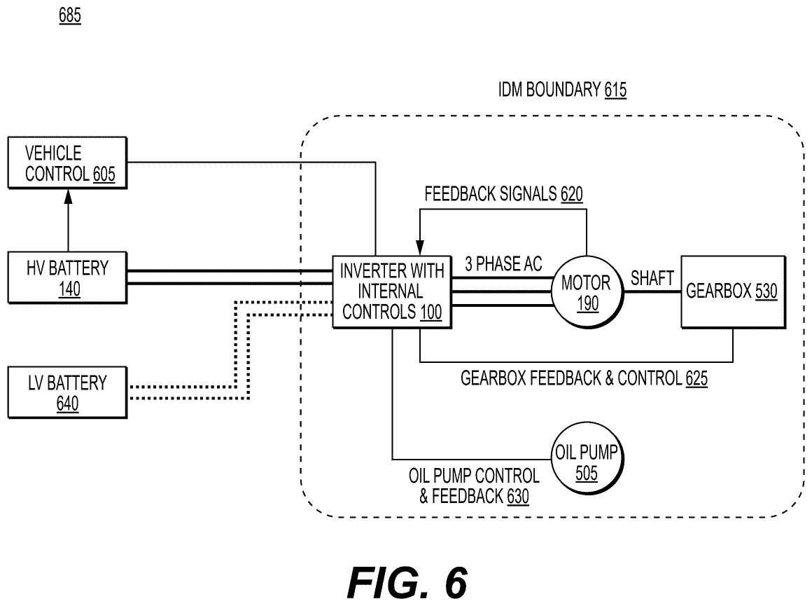

FIG. 6 depicts an exemplary system infrastructure for an IDM electrical control system 685. IDM electrical control system 685 may include vehicle controller 605, HV battery 140, low voltage (LV) battery 640, and IDM 615. IDM 615 may include power converter 100, motor 190, gearbox 530, and oil pump 505, as described in the description of FIG. 5. Vehicle controller 605 may be in communication with controller 300, may be a component of controller 300, or may be controller 300 itself. Vehicle controller 605 may monitor a temperature, for example, of HV battery 140. HV battery 140 and LV battery 640 may be connected to power converter 100. Vehicle controller 605 may monitor and control power converter 100. Power converter 100 may be connected to motor 190, gearbox 530, and oil pump 505. Power converter 100 may receive signals from motor 190 via feedback loop 620. Power converter 100 may provide three-phase power, for example, to motor 190. Power converter 100 may receive signals from and send signals to oil pump 505 via oil pump control 630. Power converter 100 may receive signals from and send signals to gearbox 530 via gearbox feedback control loop 625.

Vehicle controller 605 may communicate with power converter 100 to operate power converter 100 in an IDM inefficiency control mode. For example, vehicle controller 605 may receive temperature sensor readings from HV battery 140. Vehicle controller 605 may compare HV battery 140 temperature to a threshold temperature. The threshold temperature may be a predetermined temperature stored in a database, a Look Up Table (LUT), or other data storage area. The predetermined temperature may be generated by the manufacturers of the battery or the vehicle. The threshold temperature may be dynamically determined based on analyzing historic battery and/or vehicle data. For example, one or more machine learning (ML) algorithms may receive historic battery data, historic vehicle data, current battery data, and/or current vehicle data. The ML algorithms may analyze the received data to determine a real time threshold temperature necessary to maintain HV battery 140 for desired BEV performance. Dynamically determining the threshold temperature for desired BEV performance may provide improved results compared to a predetermined manufacturer's threshold, as the determination may consider factors unique for each vehicle and battery. For example, dynamically determining a real time threshold temperature may take into consideration wear and tear on the battery, exposure to different weather conditions, current weather condition, and other parameters unique to batteries in real time.

Vehicle controller 605 may determine to execute an IDM inefficiency control mode when the temperature of HV battery 140 falls below the temperature threshold. Vehicle controller 605 may determine to execute an IDM inefficiency mode when the ambient temperature falls below the threshold temperature. When an IDM inefficiency mode is executed, power converter 100 may activate one or more switches (e.g., upper phase switches 244, lower phase switches 248) and/or modulate signals controlling the switches (e.g., the PWM signals). Activating and modulating the switches may produce heat that may be absorbed by coolant. The heat may be transmitted to warm HV battery 140. Vehicle controller 605 may monitor the real time temperature of the HV battery 140 and adjust the inefficiency mode target power accordingly. Vehicle controller 605 may control HV battery 140 temperature by controlling the flow of coolant via oil pump control 630. For example, vehicle controller 605 may determine whether additional heat is required to bring the temperature of HV battery 140 above the threshold temperature. In cases where the motor 190, gearbox 530, and housing 535 are warmer than the coolant exiting the power converter 100, power converter 100 may send a control signal to oil pump 505 via oil pump control 630 to increase the flow of lubricant to motor 190 and gearbox 530. The increased flow of lubricant will absorb additional heat and transfer the additional heat to the coolant at WTOC 510. The coolant will then supply the additional heat to HV battery 140 and adjust until HV battery 140 reaches a threshold temperature.

In cases where the motor 190, gearbox 530, and housing 535 are cooler than the coolant exiting the power converter 100, the power converter 100 may send a control signal to oil pump 505 via oil pump control 630 to decrease the flow of lubricant to motor 190 and gearbox 530. The decreased flow of lubricant will avoid absorbing heat from the coolant in the WTOC 510. The coolant will then supply the additional heat to HV battery 140 and adjust until HV battery 140 reaches a threshold temperature.

Vehicle controller 605 may execute an IDM inefficiency control mode when the temperature of a system that is temperature-controlled by HVAC 430 falls below a temperature threshold. Vehicle controller 605 (or controller 300) may transfer the heat generated by power converter 100 into the interior of electric vehicle 185 for occupant comfort. Similarly, vehicle controller 605 may execute an IDM inefficiency control mode when the temperature of additional vehicle systems falls below a temperature threshold and transfer the heat generated by power converter 100 into those additional vehicle systems.

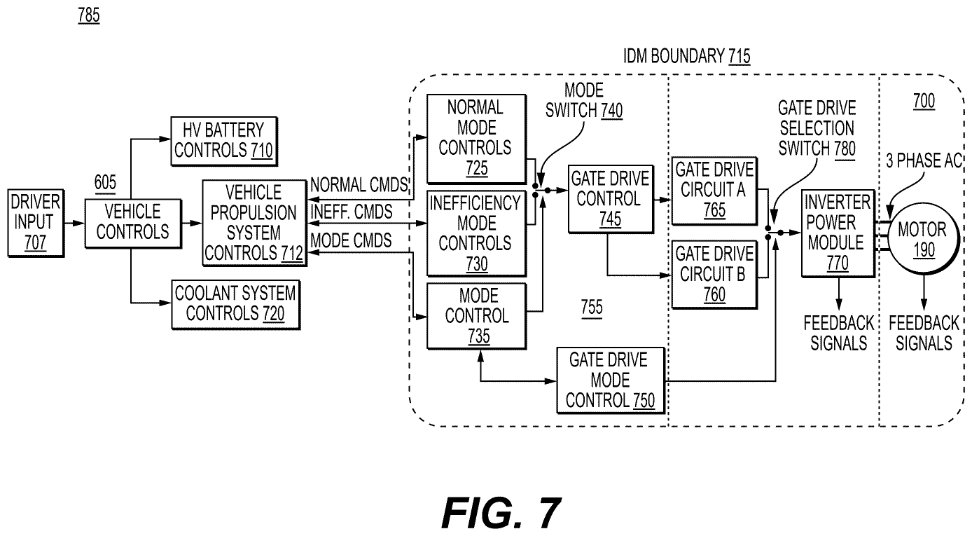

FIG. 7 depicts an exemplary system infrastructure for a vehicle and IDM control system 785. As shown in FIG. 7, vehicle and IDM control system 785 may include vehicle controller 605, HV battery controller 710, vehicle propulsion system controller 712, coolant system controller 720, and IDM 715. Vehicle controller 605 is described in the description of FIG. 6. IDM 715 may include inverter control system 755, gate drive circuit A 765, gate drive circuit B 760, gate drive selection switch 780,, inverter power module 770, and motor system 700. Inverter control system 755 may include normal mode controller (efficiency mode controller) 725, inefficiency mode controller 730, mode controller 735, mode switch 740, gate drive controller 745, and gate drive mode controller 750. Motor system 700 may include motor 190. Vehicle controller 605, HV battery controller 710, vehicle propulsion system controller 712, coolant system controller 720, normal mode controller 725, inefficiency mode controller 730, mode controller 735, gate drive mode controller 750, gate drive controller 745, inverter control system 755, and other controllers may communicate with, or may be part of, controller 300.

As shown in FIG. 7, vehicle controller 605 may receive, as input, driver input 707. Additionally and/or alternatively, vehicle controller 605 may receive, as input, communications from one or more controllers. Vehicle controller 605 may be connected to HV battery controller 710, vehicle propulsion system controller 712, and coolant system controller 720. Vehicle propulsion system controller 712 may be connected to inverter control system 755. Normal mode controller 725, inefficiency mode controller 730, and mode controller 735 may be connected to mode switch 740. Mode controller 735 may be connected to gate drive mode controller 750. Mode switch 740 may be connected to gate drive controller 745. Gate drive controller 745 may be connected to gate drive circuit A 765 and gate drive circuit B 760. Gate drive circuit A 765 and gate drive circuit B 760 may be connected to gate drive selection switch 780. Gate drive mode controller 750 may be connected to gate drive selection switch 780. Gate drive selection switch 780 may be connected to inverter power module 770. Inverter power module 770 may be connected to motor 190.

Vehicle and IDM control system 785 may be configured to control one or more systems (e.g., 485, 585) of electric vehicle 185 in an inefficient manner to produce and transport heat to HV battery 140. Heat collected from operating power converter 100 in the inefficiency mode may also be used to heat other elements of electric vehicle 185, such as the interior cabin, windows, LV battery 640, and similar vehicle parts. Vehicle and IDM control system 785 may generate heat by actuating and controlling one or more upper phase switches 244 and/or one or more lower phase switches 248. Heat produced by the switches may be transferred to the coolant systems for transfer to, for example, HV battery 140, as described in FIG. 5 and FIG. 6. The heat may be generated by increased conduction losses in power converter 100 due to switching one or more upper phase switches 244 and lower phase switches 248.

During the IDM inefficiency mode, vehicle and IDM control system 785 may send commands to inverter control system 755 to increase heat output. Inverter control system 755 may respond to this request by increasing the switching frequency of one or more upper phase switches 244 or lower phase switches 248 switches to generate and control heat output and/or by modifying the switching timing or duty cycle. One or more upper phase switches 244 or lower phase switches 248 switches may be modulated from an off-state. Toggling the one or more non-active switches between an off-state and an on-state (or a partially-on state) at high frequency and/or with a sufficient spacing (delay) between the states may provide heat without generating motor torque. One or more upper phase switches 244 or lower phase switches 248 may be modulated from an on-state.

The switching frequency in the inefficiency control mode may be higher than a switching frequency in the efficiency control mode (normal mode). The inefficiency control mode may avoid all other controls to be able to allow for shorter control loop times and much higher switching frequencies. An oscillator input circuit may also be included in the inefficiency control mode to aid in generating the higher switching frequency. The oscillator input circuit may be included in one of gate drive controller 745, gate drive circuit A 765, or gate drive circuit B 760.

Inverter control system 755 (or other controller) may repeatedly turn on all upper phase switches 244 of the inverter at the same time for a first time period, then turn off all upper phase switches 244 and turn on lower phase switches 248 at the same time at a first switching rate. The first switching rate may be above a rate employed during an efficiency control mode.

Inverter control system 755 (or other controller) may modulate the duty cycle of one or more lower phase switches 248 or upper phase switches 244 to produce a maximum drive switching frequency rate while avoiding excessive negative torque during, for example, non-zero speed operations. For example, turning on all upper phase switches 244 or lower phase switches 248 at the same time may create braking torque from the motor, thereby reducing vehicle speed and absorbing vehicle kinetic energy. Inverter control system 755 (or other controller) may modulate a duty cycle during the inefficiency mode to avoid excessive negative torque while generating heat to warm HV battery 140. The resulting losses from this control mode may be higher than those in a normal regenerative braking condition.

Inverter control system 755 (or other controller) may modulate the duty cycle of one or more of lower phase switches 248 or upper phase switches 244 switches during an inefficiency mode by modulating the delay time between the switch set triggers. In wound rotor synchronous motors, for example, a rotor field may be disabled or reduced to minimize braking torque. Modulating the switching action by creating a very slight overlap between a high switch voltage decay and a low side switch voltage rise may control the delay time or the dead time between switching transitions.

Controller 300 may provide for running an inefficiency control mode during flexible circumstances. For example, controller 300 may determine to instigate an inefficiency control mode while the vehicle is off and unoccupied, similar to a remote start. Power converter 100 (or controller 300) may run in an inefficiency control mode during a battery charging event or a pre-programmed time-of-day planned trip. Allowing inefficiency control mode activation during different vehicle circumstances may increase the amount of heat generated and reduce battery heating time. Heating during battery charging and a ‘remote start’ or programmed pre-warming mode may accomplish battery heating before the vehicle is needed by the user.

Vehicle controller 605 (or controller 300) may determine whether HV battery 140 requires additional heat based on data received from HV battery 140, driver input 707, or other sensors, such as environmental sensors. Vehicle propulsion system controller 712 may control and implement commands from vehicle controller 605 to execute either an efficiency mode of operation or an inefficiency mode of operation of the inverter. The inefficiency mode of operation may operate in a zero-torque condition at a zero speed, in a zero-torque condition at a non-zero speed, in a negative torque condition at a non-zero speed.

For instance, when vehicle controller 605 issues a command to establish an efficient operation mode, vehicle propulsion system controller 712 may direct normal commands to inverter control system 755, which may further direct commands to normal mode controller 725. When vehicle controller 605 issues a command to establish an inefficient operation mode, such as to generate heat when the HV battery 140 falls below a certain threshold, vehicle propulsion system controller 712 may direct inefficiency commands to inverter control system 755, which may further direct commands to inefficiency mode controller 730. Additionally, vehicle propulsion system controller 712 may send mode commands to inverter control system 755, which may further direct commands to mode controller 735. Based on the commands received indirectly from vehicle propulsion system controller 712, mode controller 735 may control mode switch 740 to connect the desired mode controller (normal mode controller 725 or inefficiency mode controller 730) with gate drive controller 745. Mode controller 735 may communicate with gate drive mode controller 750 to control gate drive selection switch 780 based on the mode commands indirectly received from vehicle propulsion system controller 712.

Mode switch 740, which may be controlled by mode controller 735, may connect normal mode controller (efficiency mode controller) 725 or inefficiency mode controller 730 to gate drive controller 745. Gate drive controller 745 may control gate drive circuit A 765. Alternatively, gate drive controller 745 may control gate drive circuit B 760. Gate drive mode controller 750 may control gate drive selection switch 780, thereby controlling connecting either gate drive circuit A 765 or gate drive circuit B 760 to inverter power module 770. With this structure, inverter control system 755 may command the activation of one or more of the upper phase switches 244 or one or more of the lower phase switches 248 and control (modulate) the switching frequency. For example, the one or more controllers may be configured to control the one or more upper phase switches 244 or lower phase switches 248 at a higher switching frequency in the inefficiency control mode than in the efficiency control mode.

Inverter power module 770 and motor 190 may continuously send and transmit feedback signals in a feedback loop to inverter control system 755, which may then communicate to vehicle propulsion system controller 712, controller 300, or another controller. Inverter control system 755 (or other controller) may adjust one or more duty cycles of the inefficiency mode commands based on feedback from inverter power module 770 and motor 190. To further increase switching frequency and generate additional heat, an oscillator input circuit may be switched into the gate driver for faster switching.

One or more embodiments may provide a method and system for intentionally creating an inefficiency mode for an inverter to produce heat via electrical losses. The heat may be transferred to a high voltage battery to warm the battery during cold temperatures. The inefficiency mode may induce additional heat flow into a coolant system via electrical losses without generating mechanical output torque or additional output torque. The inefficiency mode may eliminate the need for an electric coolant heater, thereby reducing vehicle cost and complexity and improving vehicle reliability.

One or more embodiments may exploit switching losses in power electronics components by creating a separate inefficiency control mode for zero-torque conditions. Alternatively, the inefficiency control mode may exploit switching losses for negative torque conditions. The inefficiency control mode may be effective at zero and non-zero speeds. The inefficiency control mode may avoid all other control calculations (ignoring rotor position etc.) to allow much shorter control loop times (and therefore much higher switching frequencies). The inefficiency control mode may allow for switching frequencies up to the limits of the power electronics devices.

One or more embodiments may increase switching losses by modulating a drive switching frequency and switching operations of the three high side switches of the inverter and the three low side switches of the inverter during an inefficiency control mode. The switching rate may be above a rate employed during an efficiency control mode. The time delay between switching operations may be modulated to produce maximum losses.

One or more embodiments may provide for operating a drive switching frequency to the maximum rate possible. These losses may result in additional heat which may be absorbed by the coolant and transferred to a HV battery. One or more embodiments may provide for modulating a duty cycle of the switches to produce a maximum drive switching frequency rate while avoiding excessive negative torque. Operating the drive switching frequency at a maximum rate may create braking torque from the motor thereby reducing vehicle speed and absorbing vehicle kinetic energy. The resulting losses from this control mode would be higher than those in a normal regenerative braking condition.

One or more embodiments may provide for controlling a duty cycle of the switches during the inefficiency mode by modulating the delay time between switch set triggers. Modulating the delay time or the dead time between transitions may involve creating a very slight overlap between high side switch voltage decay and low side switch voltage rise. The overlap may be small to avoid excessive currents in a short circuit situation. One or more embodiments may provide for maximizing energy produced by the inefficiency mode by tuning the switch-on (or partially-on) to switch-off transition to maximize energy loss of the full circuit. Tuning would not require down time to wait for a switch to fully complete a rise time event, thereby generating additional heat and reducing battery heating time.

One or more embodiments may provide for running an inverter in an inefficiency control mode during different, flexible circumstances. Designing the inefficiency control mode to run under different and varied conditions allows for greater flexibility and improved vehicle drivability and comfort. Heating during battery charging and a ‘remote start’ or programmed pre-warming mode may accomplish battery heating prior to a vehicle drive event.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system comprising a power converter, the power converter including:
one or more switches; and
one or more controllers configured to control the one or more switches in each of an efficiency control mode to operate a load and an inefficiency control mode to generate heat from the one or more switches.

2. The system of claim 1, wherein the inefficiency control mode is configured to transfer generated heat from the power converter to a coolant system.

3. The system of claim 1, wherein the inefficiency control mode operates in a zero-torque condition at a zero speed.

4. The system of claim 1, wherein the one or more switches include one or more high side switches and one or more low side switches.

5. The system of claim 1, wherein the inefficiency control mode operates in a zero-torque condition at a non-zero speed.

6. The system of claim 1, wherein the inefficiency control mode operates in a negative torque condition at a non-zero speed.

7. The system of claim 1, wherein the one or more controllers are configured to control the one or more switches in a partially-on state in the inefficiency control mode.

8. The system of claim 1, wherein the one or more controllers are configured to control the one or more switches at a higher switching frequency in the inefficiency control mode than in the efficiency control mode.

9. The system of claim 1, wherein the power converter further includes:
an oscillator input circuit for the inefficiency control mode.

10. The system of claim 1, wherein:
the one or more switches include:
one or more high side switches; and
one or more low side switches, and
in the inefficiency control mode, the one or more controllers are configured to:
turn on the one or more high side switches; and
after a first time period based on a drive switching frequency, turn off the one or more high side switches and turn on the one or more low side switches.

11. The system of claim 10, wherein the one or more controllers operating in the inefficiency control mode are further configured to control an operation of the one or more high side switches and the one or more low side switches with an overlap between a high side switch voltage decay and a low side switch voltage rise to reduce a delay time between switching the one or more high side switches and the one or more low side switches.

12. The system of claim 1, further comprising:
a motor connected to the power converter, wherein the system is provided as an electric vehicle.

13. A system comprising:
one or more controllers configured to control one or more switches of a power converter in each of an efficiency control mode to operate a load and an inefficiency control mode to generate heat from the one or more switches.

14. The system of claim 13, wherein the one or more controllers are configured to control a heat flow from the power converter to a coolant.

15. The system of claim 13, wherein the one or more controllers are configured to control heat output by modulating a duty cycle of the one or more switches.

16. The system of claim 13, wherein the one or more controllers operating in the inefficiency control mode are configured to reduce a delay time between switching operations of the one or more switches.

17. A method comprising:
controlling one or more switches of a power converter to operate in each of an efficiency control mode to operate a load and an inefficiency control mode to generate heat from the one or more switches.

18. The method of claim 17, wherein the controlling includes controlling the one or more switches to operate in the inefficiency control mode to increase one or more of a conduction loss or a switching loss of the one or more switches.

19. The method of claim 17, wherein the controlling includes controlling the one or more switches to operate in the inefficiency control mode during a remote start feature of a vehicle.

20. The method of claim 17, wherein the controlling includes controlling a duty cycle of the one or more switches operating in the inefficiency control mode to modulate a delay time between operations of the one or more switches.
